(19) United States
(12) Patent Application Publication
(10) Pub. No.: US 2020/0239816 A1
(43) Pub. Date: Jul. 30, 2020

(54) NATURAL FRAGRANCE SOAP

(71) Applicant: Hunsang KANG, Siheung-si (KR)

(72) Inventor: Hunsang KANG, Siheung-si (KR)

(21) Appl. No.: 16/262,816

(22) Filed: Jan. 30, 2019

(51) Int. Cl. C11D 9/44; C11D 9/00; C11D 9/38

(52) U.S. Cl. CPC C11D 9/442; C11D 9/38; C11D 9/007

(57) ABSTRACT

Disclosed is a natural fragrance soap comprising: a soap base in which solid component oil consisting of at least one of palm and coconut and liquid component oil consisting of horse oil are mixed; fragrance essence oil extracted from at least one of herb plants, fruits, and medicinal herbs; and a functional material containing at least one of an aloe extract, a chamomile extract, a jojoba essence, triclosan, bamboo salt, hyaluronic acid, glycerin and a moisturizer.

### TECHNICAL FIELD

The present invention relates to a natural fragrance soap.

### BACKGROUND ART

Generally, soaps are prepared by preliminarily hydrolyzing animal or vegetable oil such as beef tallow or palm oil to a fatty acid such as palmitic acid, stearic acid, or the like and glycerin, and then neutralizing the fatty acid with caustic soda or carbonic acid soda. The obtained soaps are added with various kinds of compounding agents and processed, and various kinds of soap products are completed. According to a usual use, the soaps are divided into cosmetic soap, laundry soap, industrial soap, medicinal soap and the like.

Among the soaps, the cosmetic soap is a product to which an antioxidant, a coloring agent, a flavoring agent, an abirritant, a builder (soda phosphate, soda carbonate, etc.) for enhancing detergency, and a moisturizing substance are added. The cosmetic soap has a characteristic that the soap is smelled good, has a good color, is extremely gentle to the skin and bubbles well by adding a fragrance.

However, the cosmetic soap of the soaps has a problem that it is liable to cause damage due to skin irritation to a user having the sensitive skin because artificial chemical additives and chemical fragrances are added in order to emit various good fragrances. Particularly, there is a problem that since persons directly contact the soap using the artificial chemical additive and the chemical fragrance and have a scent, the chemical elements are accumulated in the human body to provide a factor that can damage the health.

### Technical Problem

An object of the present invention is to provide a natural fragrance soap which not only solves the sense of smell by inducing a natural fragrance, but also is harmless to the human body.

Meanwhile, the technical objects to be achieved in the present invention are not limited to the aforementioned technical objects, and other technical objects, which are not mentioned above, will be apparently understood to a person having ordinary skill in the art from the following description.

### Technical Solution

In order to achieve the objects, the present invention provides a natural fragrance soap comprising: a soap base in which solid component oil consisting of at least one of palm and coconut and liquid component oil consisting of horse oil are mixed; fragrance essence oil extracted from at least one of herb plants, fruits, and medicinal herbs; and a functional material containing at least one of an aloe extract, a chamomile extract, a jojoba essence, triclosan, bamboo salt, hyaluronic acid, glycerin and a moisturizer.

The fragrance essence oil may contain coconut oil, evening primrose oil, palm oil, jojoba oil, olive oil or corn oil.

The fragrance essence oil may be contained in an amount of 0.1 to 7 parts by weight with respect to 100 parts by weight of the soap base.

The functional material may be contained in an amount of 0.1 to 5 parts by weight with respect to 100 parts by weight of the soap base.

### Advantageous Effects

According to the embodiment of the present invention, since the natural fragrance soap induces a natural fragrance to solve repulsion to the sense of smell and has an eco-friendly characteristic harmless to the human body, the natural fragrance soap is excellent in economical efficiency and safety of use.

Meanwhile, effects which can be obtained in the present invention are not limited to the aforementioned effects, and other effects, which are not mentioned above, will be apparently understood to a person having ordinary skill in the art from the following description.

### MODES OF THE INVENTION

Hereinafter, the present invention will be described in detail with reference to the accompanying drawings. First, among drawings, it should be noted that same constituent elements or components are represented by the same reference numerals. In describing the present invention, a detailed description of known functions and configurations incorporated will be omitted so as to avoid obscuring the gist of the present invention.

The terms “about”, “substantially”, and the like to be used in this specification are used as a numerical value or a value close to the numerical value when inherent manufacturing and material tolerances are presented in the stated meaning, and used to prevent an unscrupulous infringer from unfairly using disclosed contents in which precise or absolute numerical values are mentioned to help in the understanding of the present invention.

Hereinafter, an embodiment of the present invention will be described in detail with reference to the accompanying drawings.

A natural fragrance soap according to an embodiment of the present invention may be manufactured by a soap base preparing process, a fragrance essential oil adding process, and a functional material adding process.

First, both solid component oil consisting of at least one of palm and coconut and liquid component oil consisting of horse oil are weighed, and the solid component oil and the liquid component oil are mixed and then heated to 70° C. to 95° C.

On the other hand, it is preferable that the base oil is mixed in a ratio of 300 g to 350 g of the liquid component oil to 400 g to 450 g of the solid component oil.

Here, the horse oil is the fat component extracted from the fatty tissue of horses. In the Chinese classical medicines of “Medical Diagnosis” and ‘Compendium of Materia Medica’, effects of horse oil creams such as ‘giving hair,’ ‘healing the hands and feet,’ ‘helping blood circulation’ and the like have been reported, and the horse oil is widely used as a remedy for burns and atopic dermatitis in Asian countries from ancient times to have the record of being used as medicines in China in the 5th and 6th centuries. Palmitoleic acid, ceramide, and the like are included as main ingredient of the horse oil, and the ingredients are very similar to human sebum, has high affinity with the human skin, and contain more than 60% of unsaturated fatty acid to have the limelight as cosmetic raw material capable of supplying unsaturated fatty acid to the skin.

The horse oil may be oil (refined horse oil) refined after dissolving fat meat of the horse. Preferably, the fat meat of the horse is cut finely and melted in a hot plate at a temperature of 60 to 100° C., and then filtered using a filter paper in a dry oven to obtain the horse oil.

In particular, since the color and the odor of the fat meat of the slaughtered horse vary according to the state and age of the horse, and a fat meat part, when selecting the fat meat, the fat meat should be selected carefully by being fully aware of the point.

Therefore, when the horse fat meat of which the color is close to yellow and the order is strong is selected, the horse fat meat is not suitable to be selected as a pharmaceutical composition or a cosmetic material because the yellow color remains after the filtration process and the odor is severe. In this case, the horse suitable for extracting the horse oil is suitable for horse within 6 years of age, and in case of using horse of 6 years or more, especially 7 to 10 years of age, the horse oil is not suitable for use as cosmetics because special odor is severe even if the horse oil is purified.

That is, in the embodiment of the present invention, horse of 6 years or less of age may be selected to obtain the horse oil.

There is provided a soap base composition which is prepared from the reaction between the solid component oil and the liquid component oil. The reaction is heated to a temperature of 70° C. to 95° C., and the soap base composition prepared has a pH of about 9.0 to about 10.5.

Here, oil used as a reactant may be one selected from the group consisting of olive oil, sunflower seed oil, corn oil, coconut oil, palm oil, palm kernel oil, castor oil, and any combination thereof.

Next, sodium hydroxide is weighed and then poured into and dissolved in the prepared mixed solution. Then, the mixed solution added with sodium hydroxide is poured into the heated fatty acid and stirred until being thick.

Next, the mixture is added with glycerin and ethanol and heated to 75° C. to 80° C. while stirring so that the lump is loosened.

Thereafter, the mixture is stirred for 10 minutes, then slightly more heated by adding fragrance essence oil and a functional material (about 85° C.).

Here, the fragrance essence oil may be extracted from any one of herb plants, fruits, and medicinal herbs.

The herb plants may include at least one of tea tree, Eucalyptus and peppermint.

The fruits may include natural fragrances extracted from fruits such as oranges, lemons, grapefruits, apples, pears, peaches, and the like.

The medicinal herbs may include at least one of lavender, peppermint, pine needles, cypress, Angelica, and cnidium.

Here, the efficacy of the medicinal herbs may be as follows.

Lavender: nervous mental stability, insomnia, depression, anxiety;

Pine needles: nerve stability, blood circulation, hyperthymia;

Cypress leaves: mind and body stability, metabolism, relieve stress;

Peppermint: nervousness, headache, hyperthymia, concentration; and

Angelica, and cnidium: blood circulation, hyperthymia.

In addition, the functional material may include at least one of an aloe extract, a chamomile extract, a jojoba essence, triclosan, bamboo salt, hyaluronic acid, glycerin and a moisturizer.

Here, the fragrance essence oil may be contained in an amount of 0.1 to 7 parts by weight with respect to 100 parts by weight of the soap base. As a result, the fragrance essence oil may precisely control the degree of a required fragrance without breaking the basic properties of the soap base.

Meanwhile, the functional material may be contained in an amount of 0.1 to 5 parts by weight with respect to 100 parts by weight of the soap base. As a result, the functional material such as an aloe extract, a chamomile extract, a jojoba essence, triclosan, bamboo salt, hyaluronic acid, glycerin and a moisturizer is mixed.

Finally, while stirring for about 20 minutes, the mixture is stirred to make a clear liquid.

Thereafter, the mixture is poured into a desired mold and hardened according to a type of soap to be made. When the mixture is hardened after a lapse of time, the mixture is separated from the mold and aged for 4 weeks in a dry place to manufacture a soap.

In another embodiment, the soap base may be molten in a liquid form by mixing solid component oil consisting of at least one of palm and coconut with liquid component oil consisting of horse oil, curing a white base, cutting the cured white base by a dicing method, and then containing the cut white base and a transparent base in a stainless steel beaker, and then heating (70° C. to 95° C.) in a hot plate.

Thereafter, the fragrance essence oil and the functional material may be sequentially added to the molten liquid soap base.

Here, the fragrance essence oil may be contained in an amount of 0.1 to 7 parts by weight with respect to 100 parts by weight of the soap base, and the functional material may be contained in an amount of 0.1 to 5 parts by weight with respect to 100 parts by weight of the soap base.

Meanwhile, the functional material may be composed of liquid or solidified powder.

Then, the liquid soap base in which the fragrance essence oil and the functional material are mixed is poured into a mold for soap molding and hardened. When the hardened soap base is separated from the mold and aged for 4 weeks in a dry place to manufacture the soap.

As described above, the present invention is not limited to the aforementioned embodiments and the accompanying drawings, and it will be obvious to those skilled in the technical field to which the present invention pertains that various substitutions, modifications, and changes may be made within the scope without departing from the technical spirit of the present invention.

What is claimed is:

1. A natural fragrance soap comprising:
a soap base in which solid component oil consisting of at least one of palm and coconut and liquid component oil consisting of horse oil are mixed;
fragrance essence oil extracted from at least one of herb plants, fruits, and medicinal herbs; and
a functional material containing at least one of an aloe extract, a chamomile extract, a jojoba essence, triclosan, bamboo salt, hyaluronic acid, glycerin and a moisturizer.

2. The natural fragrance soap of claim 1, wherein the fragrance essence oil contains coconut oil, evening primrose oil, palm oil, jojoba oil, olive oil or corn oil.

3. The natural fragrance soap of claim 2, wherein the fragrance essence oil is contained in an amount of 0.1 to 7 parts by weight with respect to 100 parts by weight of the soap base.

4. The natural fragrance soap of claim 3, wherein the functional material is contained in an amount of 0.1 to 5 parts by weight with respect to 100 parts by weight of the soap base.
